(19) United States
(12) Patent Application Publication
(10) Pub. No.: US 2020/0265494 A1
(43) Pub. Date: Aug. 20, 2020

(54) REMOTE SKU ON-BOARDING OF PRODUCTS FOR SUBSEQUENT VIDEO IDENTIFICATION AND SALE

(71) Applicant: Grabango Co., Berkeley, CA (US)

(72) Inventors: William Glaser, Berkeley, CA (US); Brian Van Osdol, Piedmont, CA (US)

(21) Appl. No.: 16/793,343

(22) Filed: Feb. 18, 2020

Related U.S. Application Data
(60) Provisional application No. 62/806,821, filed on Feb. 17, 2019.

(51) Int. Cl. G06Q 30/06; G06Q 10/08; G06K 9/00; G06K 9/32

(52) U.S. Cl. CPC G06Q 30/0627; G06K 9/3241; G06K 9/00671; G06Q 10/087

(57) ABSTRACT

A system and method for remote SKU on-boarding of products for identification and sale which can include collecting image data in an environment; triggering computer vision detection of an item; processing the image data for item detection; relaying item related image data to a product mapping tool upon detection of item detection exception; presenting image data in the product mapping tool and receiving product identifier input; and updating a computer vision monitoring system in response to the product identifier input.

### CROSS-REFERENCE TO RELATED APPLICATIONS

This application claims the benefit of U.S. Provisional Application No. 62/806,821, filed on 17 Feb. 2019, which is incorporated in its entirety by this reference.

### TECHNICAL FIELD

This invention relates generally to the field of computer vision product detection, and more specifically to a new and useful system and method for remote on-boarding of products for subsequent video identification and sale.

### BACKGROUND

Recent trends have seen increasing use of computer vision and other forms of machine learning in the retail space. For these systems, dedicated training of computer vision models for the detection and identification of products has been used. Many existing solutions use time-consuming product on-boarding processes that require products to be individually scanned using complex scanning setups so that a computer vision model is trained on detecting the product from a variety of angles and situations. This process is expensive and time consuming. This solution also fails to realistically address the challenges of identifying products in a real retail setting where product inventory can include several thousand different products and will regularly change with the introduction of new products and changes in packaging of products. For example, any changes to product marketing or introduction of a new product would require dedicated scanning before the item could be handed by the current systems. Thus, there is a need in the computer vision product detection field to create a new and useful system and method for remote on-boarding of products for subsequent video identification and sale. This invention provides such a new and useful system and method.

### BRIEF DESCRIPTION OF THE FIGURES

FIG. 1 is a schematic representation of a system of a preferred embodiment;

FIGS. 2 and 3 are exemplary screenshots of a variations of a product mapping tool;

FIG. 4 is a flowchart representation of a method of a preferred embodiment;

FIG. 5 is a schematic representation of an exemplary application of the method to updating the environment model in an automated checkout variation;

FIG. 6 is a schematic representation of an exemplary application of the method to updating the environment model for generating and maintaining a planogram;

FIG. 7 is a schematic representation of an exemplary application of the method to augmenting the CV processing model based on the product identifier input; and

FIG. 8 is an exemplary system architecture that may be used in implementing the system and/or method.

### DESCRIPTION OF THE EMBODIMENTS

The following description of the embodiments of the invention is not intended to limit the invention to these embodiments but rather to enable a person skilled in the art to make and use this invention.

### 1. Overview

A system and method for remote on-boarding of products for subsequent video identification on-boarding products for computer vision detection of a preferred embodiment functions to support on-demand on-boarding of products in an environment. More specifically, the system and method enable a reactive solution that remotely on-boards and enrolls items for product identification (e.g., Stock Keeping Unit/SKU identification) to continually expand the capabilities of a computer vision monitoring system. The system and method are preferably applied in the detection of products in a retail environment for CV related applications.

The system and method can be applied in a variety of applications but preferably can be used in improve the CV monitoring capabilities and/or supplement a monitoring system's tracked model of an environment. In one preferred application, the system and method can be used to augment product identification and the sale of items. The system and method can be used in combination with a CV-driven technology solution for some form of automated checkout such as checkout-free shopping and/or assisted checkout. The system and method can preferably be used such that a CV monitoring system can maintain an updated model for reliably and consistently identifying products despite the introduction of new products and changes in packaging of existing products. In another exemplary application, the system and method can be applied to the generation and maintaining of a planogram or some other form of an item placement map within an environment. The system and method may additionally or alternatively be used for inventory tracking, operational and logistic management, and/or other suitable solutions.

While the system and method are primarily described as they could be used in handling the detection of physical products in a retail setting, the system and method could similarly be used in other applications that rely on the detection of different items. The system and method may be particularly applicable to applications with a large variety of items that continuously changes.

The system and method preferably leverage remote human resources to supplement computer vision monitoring. The system and method can provide a variety of tools to assist in the detection of items and/or the human mapping of product identifiers to image data of an item.

As one preferred environment for implementation, the system and method can be used in a retail environment. A grocery store is used as an exemplary retail environment in the examples described herein, however the system and method is not limited to retail or to grocery stores. In other examples, the system and method can be used in supermarkets, department stores, apparel stores, bookstores, hardware stores, electronics stores, gift shops, and/or other types of shopping environments. The system and method may alternatively be used in any suitable environment that could benefit from item detection.

In one preferred implementation, the system and method are used in combination with a monitoring system used for automated or semi-automated checkout. Herein, automated and/or semi-automated checkout is primarily characterized by a system or method that generates or maintains a virtual cart (i.e., a checkout list) during the shopping experience with the objective of tracking the possessed or selected items for billing a customer. The checkout process can occur when a customer is in the process of leaving a store. The checkout process could alternatively occur when any suitable condition for completing a checkout process is satisfied such as when a customer selects a checkout option within an application.

A virtual cart may be maintained and tracked during a shopping experience through use of one or more monitoring system. In performing an automated checkout process, the system and method can automatically charge an account of a customer for the total of a shopping cart and/or alternatively automatically present the total transaction for customer completion. Actual execution of a transaction may occur during or after the checkout process in the store. For example, a credit card may be billed after the customer leaves the store. Alternatively, single item or small batch transactions could be executed during the shopping experience. For example, automatic checkout transactions may occur for each item selection event. Checkout transactions may be processed by a checkout processing system through a stored payment mechanism, through an application, through a conventional PoS system, or in any suitable manner.

One variation of a fully automated checkout process may enable customers to select items for purchase (including produce and/or bulk goods) and then leave the store. The automated checkout system and method could automatically bill a customer for selected items in response to a customer leaving the shopping environment. The checkout list can be compiled using computer vision and/or additional monitoring systems. In a semi-automated checkout experience variation, a checkout list or virtual cart may be generated in part or whole for a customer. The act of completing a transaction may involve additional systems. For example, the virtual cart can be synchronized with (or otherwise transmitted to) a point of sale (POS) system manned by a worker so that at least a subset of items can be automatically entered into the POS system thereby alleviating manual entry of the items.

The system and method can be used in pre-identifying items on shelves in anticipation of user-item interaction and/or for detection of an item involved in a user-item interaction (e.g., picking up an item for purchase). The system and method could alternatively be implement without any form of automated checkout.

The system and method may provide a number of potential benefits. The system and method are not limited to always providing such benefits, and are presented only as exemplary representations for how the system and method may be put to use. The list of benefits is not intended to be exhaustive and other benefits may additionally or alternatively exist.

As one potential benefit, the system and method function as a faster on-boarding process for products. As opposed to performing dedicated scans of each product, the system and method may more regularly perform ad-hoc labeling of products and collect training data from an items normal storage location and while the item is observed within the store. In practical implementation, a product can be added to the system for detection and tracking at the time of its discovery in the store.

As another benefit, the system and method may use the product identification of an item to incorporate item related image data into a CV processing model. In this way a new or changed product can have relevant image data so that the CV processing model can improve and at some point succeed in identifying other instances of that product.

As another benefit, the system and method can be reactive to real, in-store conditions. A CV monitoring system can be alleviated from being limited to only products that were pre-enrolled during an involved on-boarding process, which may involve a non-trivial scanning process. To a store operator, the approach of the system and method can enable them to maintain typical retail logistics while also adding capabilities provided through the CV monitoring system.

The system and method can be resilient to managing visual detection of a set of items when the set of items is constantly changing at least from a visual appearance standpoint. New products may be added to the inventory at a weekly, a daily, an hourly, and/or any suitable interval. In addition to new products, existing products may have visual changes due to packaging changes, marking changes (e.g., adding a discount sticker), and/or other suitable changes that may impact the visual appearance of a product. Similarly, old products or old packaging may be decommissioned or no longer used.

As another related benefit, the system and method can enable a streamlined deployment of the computer vision monitoring system into an environment. Any particular store and/or type of store may have its own unique set of products. In the extreme case, none of those products are registered for detection. The system and method may be applied for on-boarding of a full inventory. More typically, when starting the CV monitoring system in an environment that is similar to a previously monitored environment, the system and method can be used for dynamically on-boarding portions of the inventory that were previously never integrated into the CV monitoring system.

As yet another potential benefit, the system and method can provide enhanced labeling tools for use by human workers and/or automated systems. The system and method can enable customized human computer user interfaces to increase efficiency by which human labeling tasks can be achieved through a computer interface.

As another benefit, the system and method can facilitate quickly addressing individual item identification task. This may serve at reducing product identification latency. The item identification task can be augmented with intelligence to make the task of determining and inputting a product identifier into a product mapping tool easier. This may serve to make this form of product identification usable in applications where there may be limited time to properly detect the item such as in automated checkout applications.

As another potential benefit, the system and method may alleviate the CV monitoring system from using or being dependent on shelf planograms (e.g., a set map of product placement in a store). The system and method use object detection that is fully or partially independent of a fixed planogram. In some cases, nearby objects on a shelf (e.g., a real-time planogram) may be used. Some legacy solutions use fixed planograms to drive product identification. However, such static planogram-related approaches are not as a resilient to the reality of an operating store and can require considerable overhead to maintain products in the set planogram configuration. The system and method are preferably significantly more flexible to variations and changes to an expected planogram.

### 2. System

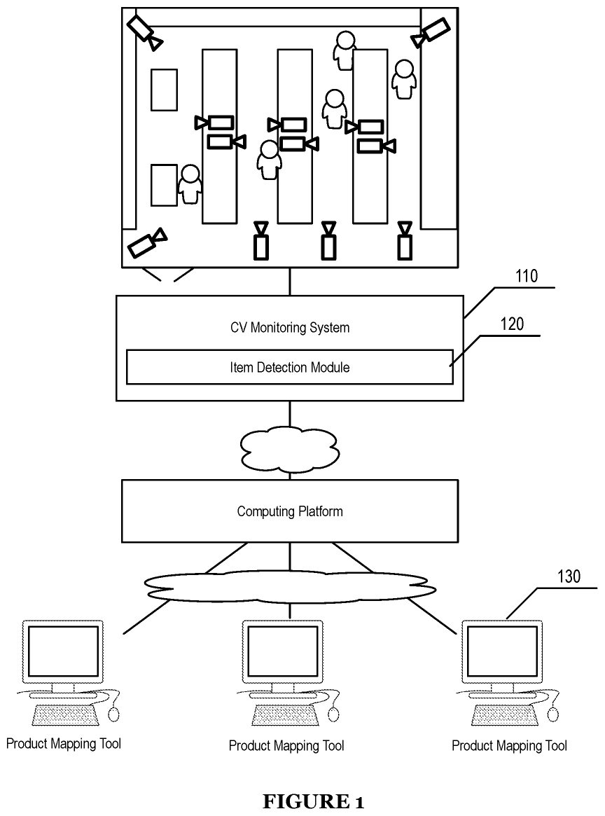

As shown in FIG. 1, a system for remote product on-boarding for a computer vision system of a preferred embodiment can include a computer vision monitoring system 110 integrated into at least one environment; the CV monitoring system 110 including at least one item detection module 120; and a product mapping tool 130. The computer vision (CV) monitoring system 110 preferably collects image data and performs item detection through the item detection module 120. An item can be transferred to the product mapping tool 130 upon detection of the item as one that cannot be identified, identified as a non-registered product, identified with low confidence (e.g., below a configured minimum confidence level), and/or otherwise needing supplemental identification processing. The product mapping tool 130 is preferably hosted or offered through a client device remote to the environment.

The environment that hosts the CV monitoring system 110 and described herein is preferably one with a set of items intended for identification. Preferably, at least a subset of the items is identifiable and integrated for CV-based monitoring through the item detection module 120. Another subset of items may not be identifiable, and the system functions to transition these items to be included in the set of identifiable items. In some variations, the system can take an environment with no items having previously been enrolled for identification, and the system can facilitate on-boarding all or a portion of the items for identification.

Herein, reference to items preferably characterizes items intended for at least one form of identification or detection. In a retail environment, the items may alternatively be referred to as products, where identification may refer to identification of an item-associated product identifier like a stock-unit identifier (SKU identifier), a universal product code (UPC), a Price Look-Up code (PLU code) for produce, an International Standard book Number (ISBN) for books, or any suitable type of product record. Item detection preferably characterizes identification of the item (e.g., identifying a corresponding SKU ID) and identification of a location of the item. Location can be location within the image but may also be transformed into a real-world location such as the location on a shelf in a retail environment. The environment will generally also include other types of physical objects such as people, environment infrastructure (e.g., shelves, lights, signage, etc.), and other types of objects. The system preferably primarily deals with establishing CV identification capabilities of a CV monitoring system 110 and associating the resulting item to a product record. The system may additionally or alternatively assist in classifying which objects are considered products and non-products. For example, the system could enable enhancing the CV monitoring system 110 from properly handling a non-product item in the environment as such.

The system is preferably implemented within one environment. In some variations, the system may include a distributed system where multiple CV monitoring system 110 instances are operated across multiple distinct environments. For example, instances of the CV monitoring system 110 could be installed in multiple stores across a city, country, or the world. In some cases, the different environments may have substantially shared item detection modules 120 such as for store chains with substantially similar store inventories. In other cases, two different environments may have different inventories, possibly sharing only partly shared inventories. Different item detection modules 120 may be used for each of these two environments. The system may include a network accessible management platform or system that facilitates interactions between the various elements of the system.

A CV monitoring system 110 of a preferred embodiment functions to transform image data collected within the environment into observations relating in some way to items in the environment. Preferably, the CV monitoring system 110 is used for detecting items, monitoring users, tracking user-item interactions, and/or making other conclusions based on image and/or sensor data. The CV monitoring system 110 will preferably include various computing elements used in processing image data collected by an imaging system. In particular, the CV monitoring system 110 will preferably include an imaging system and a set of modeling processes and/or other processes to facilitate analysis of user actions, item state, and/or other properties of the environment.

The CV monitoring system 110 preferably provides specific functionality that may be varied and customized for a variety of applications. In addition to item identification, the CV monitoring system 110 may additionally facilitate operations related to person identification, virtual cart generation, item interaction tracking, store mapping, and/or other CV-based observations. Preferably, the CV monitoring system 110 can at least partially provide: person detection; person identification; person tracking; object detection; object classification; object tracking; gesture, event, or interaction detection; detection of a set of customer-item interactions, and/or forms of information.

In one preferred embodiment, the system can use a CV monitoring system 110 and processing system such as the one described in the published US Patent Application 2017/0323376 filed on May 9, 2017, which is hereby incorporated in its entirety by this reference. The CV monitoring system 110 will preferably include various computing elements used in processing image data collected by an imaging system.

The imaging system functions to collect image data within the environment. The imaging system preferably includes a set of image capture devices. The imaging system might collect some combination of visual, infrared, depth-based, lidar, radar, sonar, and/or other types of image data. The imaging system is preferably positioned at a range of distinct vantage points. However, in one variation, the imaging system may include only a single image capture device. In one example, a small environment may only require a single camera to monitor a shelf of purchasable items. The image data is preferably video but can alternatively be a set of periodic static images. In one implementation, the imaging system may collect image data from existing surveillance or video systems. The image capture devices may be permanently situated in fixed locations. Alternatively, some or all may be moved, panned, zoomed, or carried throughout the facility in order to acquire more varied perspective views. In one variation, a subset of imaging devices can be mobile cameras (e.g., wearable cameras or cameras of personal computing devices). For example, in one implementation, the system could operate partially or entirely using personal imaging devices worn by users in the environment (e.g., workers or customers).

The imaging system preferably includes a set of static image devices mounted with an aerial view from the ceiling or overhead. The aerial view imaging devices preferably provide image data that observes at least the users in locations where they would interact with items. Preferably, the image data includes images of the items and users (e.g., customers or workers). While the system (and method) are described herein as they would be used to perform CV as it relates to a particular item and/or user, the system and method can preferably perform such functionality in parallel across multiple users and multiple locations in the environment. Therefor, the image data may collect image data that captures multiple items with simultaneous overlapping events. The imaging system is preferably installed such that the image data covers the area of interest within the environment.

Herein, ubiquitous monitoring (or more specifically ubiquitous video monitoring) characterizes pervasive sensor monitoring across regions of interest in an environment. Ubiquitous monitoring will generally have a large coverage area that is preferably substantially continuous across the monitored portion of the environment. However, discontinuities of a region may be supported. Additionally, monitoring may monitor with a substantially uniform data resolution or at least with a resolution above a set threshold. In some variations, a CV monitoring system 110 may have an imaging system with only partial coverage within the environment.

A CV-based processing engine and data pipeline preferably manages the collected image data and facilitates processing of the image data to establish various conclusions. The CV-based processing engine and data pipeline is preferably comprises of one or more computer processors (e.g., CPU, GPU, FBPGA, application-specific integrated circuit/ASIC) with machine-readable instructions stored on a machine-readable storage medium. The machine-readable instructions when executed cause the processors to perform one or more of the processes described herein. The various CV-based processing modules are preferably used in detecting items (e.g., locating and identifying), generating user-item interaction events, a recorded history of user actions and behavior, and/or collecting other information within the environment. The CV-based processing engine and data pipeline can further manage modeling a data-representation of the environment. Such an environment model can represent some sensed or predicted state of the environment such as the products stocked on shelves or the current state of a virtual cart of a detected customer. The data processing engine can reside local to the imaging system or capture devices and/or an environment. The data processing engine may alternatively operate remotely in part or whole in a cloud-based computing platform.

User-item interaction processing modules function to detect or classify scenarios of users interacting with an item. User-item interaction processing modules may be configured to detect particular interactions through other processing modules. For example, tracking the relative position of a user and item can be used to trigger events when a user is in proximity to an item but then starts to move away. Specialized user-item interaction processing modules may classify particular interactions such as detecting item grabbing or detecting item placement in a cart. User-item interaction detection may be used as one potential trigger for an item detection module 120.

A person detection and/or tracking module functions to detect people and track them through the environment.

A person identification module can be a similar module that may be used to uniquely identify a person. This can use biometric identification. Alternatively, the person identification module may use Bluetooth beaconing, computing device signature detection, computing device location tracking, and/or other techniques to facilitate the identification of a person. Identifying a person preferably enable customer history, settings, and preferences to be associated with a person. A person identification module may additionally be used in detecting an associated user record or account. In the case where a user record or account is associated or otherwise linked with an application instance or a communication endpoint (e.g., a messaging username or a phone number), then the system could communicate with the user through a personal communication channel (e.g., within an app or through text messages).

A gesture, event, or interaction detection modules function to detect various scenarios involving a customer. One preferred type of interaction detection could be a customer attention tracking module that functions to detect and interpret customer attention. This is preferably used to detect if, and optionally where, a customer directs attention. This can be used to detect if a customer glanced in the direction of an item or even if the item was specifically viewed.

The item detection module 120 of a preferred embodiment, functions to detect and apply an identifier to an object. The item detection module 120 preferably performs a combination of object detection, segmentation, classification, and/or identification. This is preferably used in identifying products or items displayed in a store. Preferably, a product can be classified and associated with a product identifier such as a SKU identifier. In some cases, a product may be classified as a general type of product. For example, a carton of milk may be labeled as milk without specifically identifying the SKU of that particular carton of milk. Identification of an item of an item type without a specific product identifier may be used in triggering product identification through the product mapping tool 130. The item detection model 120 can comprise of one or more CV processing models. A CV processing model can be a neural network, a convolutional neural network (CNN), a region-based CNN (R-CNN), Fast R-CNN, and/or other object detection and identification processing models. An object tracking module could similarly be used to track items through the store in the event an item is moved.

In a successfully trained scenario, the item detection module 120 properly identifies a product observed in the image data as being associated with a particular product identifier. In that case, the CV monitoring system 110 and/or other system elements can proceed with normal processing of the item information. In an unsuccessful scenario (i.e., an exception scenario), the item detection module 120 fails to fully identify a product observed in the image data. An exception may be caused by inability to identify an object, but could also be other scenarios such as identifying at least two potential identifiers for an item with sufficiently close accuracy, identifying an item with a confidence below a certain threshold, and/or any suitable condition whereby a remote item labeling task could be beneficial. In this case the relevant image data is preferably marked for labeling and/or transferred a product mapping tool 130 for human assisted identification. The results of labeling through the product mapping tool 130 may be used in updating and/or enhancing the CV processing model of the item detection module 120.

The item detection module 120 in some variations may be integrated into a real-time inventory system. The real-time inventory system functions to detect or establish the location of inventory/products in the environment. The real-time inventory system can manage data relating to higher level inventory states within the environment. For example, the inventory system can manage a location/position item map, which could be in the form of a planogram. The inventory system can preferably be queried to collect contextual information of an unidentified item such as nearby items, historical records of items previously in that location, and/or other information. Additionally, the inventory system can manage inventory data across multiple environments, which can be used to provide additional insights into an item. For example, the items nearby and/or adjacent to an unidentified item may be used in automatically selecting a shortened list of items used within the product mapping tool 130.

Alternative forms of CV-based processing modules may additionally be used such as customer sentiment analysis, clothing analysis, customer grouping detection (e.g., detecting families, couples, friends or other groups of customers that are visiting the store as a group), and/or the like. The system may include a number of subsystems that provide higher-level analysis of the image data and/or provide other environmental information such as a real-time virtual cart system.

The real-time virtual cart system functions to model the items currently selected for purchase by a customer. The virtual cart system may enable automatic self-checkout or accelerated checkout. Product transactions could even be reduced to per-item transactions (purchases or returns based on the selection or de-selection of an item for purchase). The virtual cart system may be integrated with the system to provide purchase or planned purchase information, which may be used as a condition for delivering content. The type of content delivered to customer may be based in part on their current cart contents. For example, a coupon may be selected and delivered to a customer for a particular brand of ketchup buns based in part on the customer having hamburger buns and ground beef in the cart.

The product mapping tool 130 of a preferred embodiment functions to facilitate labeling items in image data and establish an association to a product identifier. The product mapping tool 130 is preferably a graphical user interface presented through a client device. The product mapping tool 130 can be a web application or native client application. The product mapping tool 130 is preferably used by a human user to resolve the identification and mapping of a viewed item (e.g., product) with a label/identifier (e.g., a product identifier). In general, the user will be enabled to view the item and then select or indicate an appropriate identifier.

The product mapping tool 130 is preferably communicatively coupled to the CV monitoring system 110 through a network communication channel, and as such the product mapping tool 130 can be operated on a client device remote to the environment. In some instances or implementations, the product mapping tool 130 can be operated on a device local to the environment. The product mapping tool 130 is preferably a website, application, or other suitable user interface operable on a client device. A client device can be any suitable processor-implemented computer such as a personal computer, a tablet, or any suitable type of computer. Preferably the client device will have a graphical display so that item related image data can be presented. Furthermore, user interface elements presented through the graphical display can be used in receiving a user indicated product identifier input.

There are preferably multiple instances of the product mapping tool 130 such that multiple users can assist in identifying products. The various instances will preferably manage identification tasks for a plurality of environments but may be dedicated for one specific environment or type of environment.

The product mapping tool 130 preferably acts on an item identification task, herein referred to as a task. Tasks are preferably served to the product mapping tool 130 in substantially real-time, where real-time characterizes delivering in response to occurrence of an event with allowances for communication latency, processing, and other system execution time. Tasks may alternatively be handled at any suitable time. In some variations, a task management system can manage collection of assigning the same task to multiple agents for redundancy, evaluating quality, and assessing agent performance.

Tasks may additionally be prioritized and/or queued according to various rules, heuristics or models. In one variation, a first type of task may be prioritized over a second type of task based on a relationship to a virtual checkout and the ability to facilitate an automated or semi-automated checkout experience. For example, if a customer has a virtual cart that has been modeled with high confidence, then an unidentifiable product that they select may be prioritized over a second product so as to possibly preserve the ability to facilitate an automated/semi-automated checkout experience. As a counter example, a customer with a virtual cart that has an exception (e.g., previous monitoring errors, having a product needing ID check, etc.), then any tasks related to unidentified products selected by the customer may be deprioritized in a queue. In this counter example, handling of the task not in real-time may not prevent an automated checkout experience. In another variation, the prioritization of tasks can be based on an expectation or prediction of a checkout event. For example, a labeling task for an unidentified product in a virtual cart of a user that is near a checkout region may be prioritized over a second labeling task for an unidentified product in a virtual cart of a second user that is far from a checkout region. There may be more time to perform the task for the second user.

Tasks may additionally be ordered for handling based on the trigger event. Detection of an unidentified item from user/customer interaction will generally be given a higher priority than a task triggered based on worker or non-interaction events (e.g., a stocking event).

The product mapping tool 130 will generally include a view to present image data relating to a particular item. The image data may be automatically cropped, centered, or otherwise presented to highlight the product. Image data from multiple vantage points collected from different imaging devices can similarly be collected and presented. Historical image data may additionally be presented. For example, image data from different time periods but at the location of the item can be collected. Image data of the stocking event in particular may be useful in identifying the product as the shipping container may more clearly identify the product.

The image data is preferably presented through a navigable interface. An image navigation and viewing interface can enable a user to browse and review relevant data to assist in visually and contextually identifying a product.

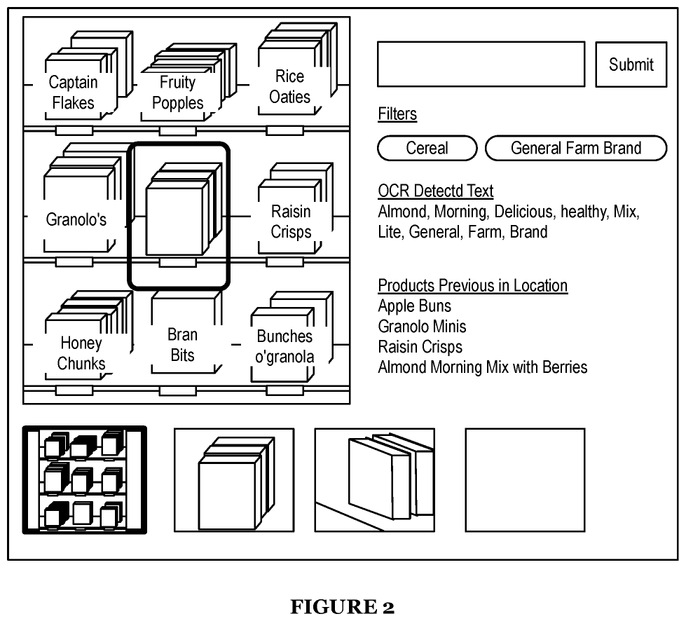

Relevant contextual information can additionally be presented in the product mapping tool 130 as shown in FIG. 2. This may include pricing or signage information. For example, the image data of the price tag can be extracted and presented. The adjacent items may additionally indicate relevant information. Adjacent items, if identified, may be presented using data using their product identifier (e.g., pulling stock images of the product, or product name, etc.). Image data of adjacent items may additionally or alternatively be presented.

In some cases, adjacent product information, previous product information (e.g., products previously stocked at that or nearby locations), aisle information, and/or other information can also be presented. In some cases, the contextual information may be based in part on data from other environments. For example, a list of reference products stocked in a similar location can be presented based on stocking information/planograms from other stores.

In a basic implementation, the product mapping tool 130 presents relevant information, and then the user uses an input field to enter a product identifier. In some cases, the agent may use external tools to assist in identifying a product.

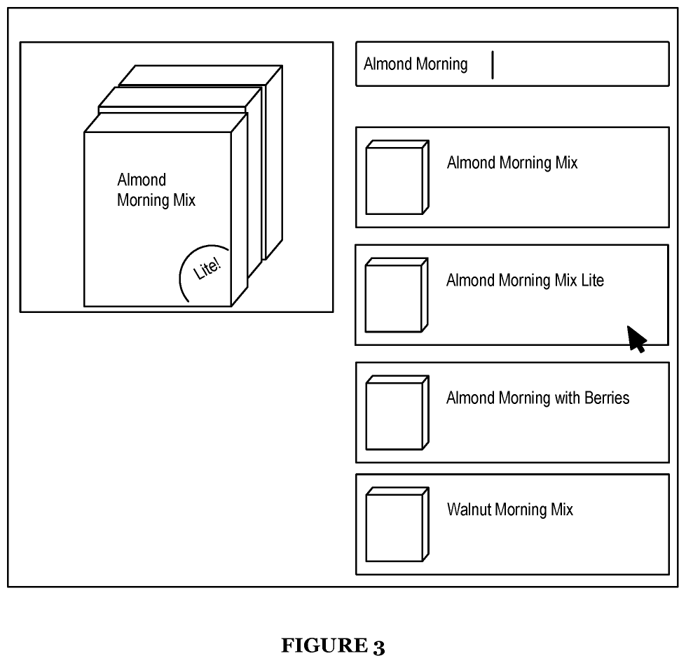

The product mapping tool 130 may additionally include one or more forms of assistance modes. As one basic tool, a product search and autocompletion tool may collect a query input and generate a prioritized list of candidate product items from which an agent can select a product as shown in FIG. 3. The product identifier can preferably be automatically pulled from the selected product option if it exists.

Autocompletion can use various data inputs to facilitate generating the prioritized list of candidate products. The data inputs can include CV monitoring analysis results, adjacent product information, stocking history of the store, stocking history of other stores, previous product identification tasks at or near that location, aisle information, customer cart information, stocking information, and/or other supplemental information. In the event that the task is associated with one or more users, such as when the user picked up the unidentifiable item, then the candidate products may be based in part on the shopping data of the user. For example, the types of cereal previously purchased by a user can be used in generating a set of candidate products when the item is a cereal box or is located in the breakfast aisle. In some variations, these various inputs may be inputs into a machine learning model, a heuristical model, statistical model, and/or other suitable processing modules.

Additionally, the agent may supply partial identifying information such as brand name, product description, partial product name, price information,

An autocompletion mode will preferably present image data of the various products. In some cases, the image data of the products may highlight differences between other options. For example, if the list includes three yogurt containers that include a “whole milk” option, a “low fat milk” option, and an “organic” option, then the product image segments with visual differences may be highlighted in a primary image or a secondary image. This may be used to signal to a human where the packaging differences exist to distinguish between the different options. Image annotations may additionally be supplied. For example, an annotation may indicate the color associated with a particular variety of a product item. Alternatively, the candidate products may be presented as selectable items without an accompanying image of the product.

In addition to providing autocompletion options, the product mapping tool 130 can present candidate product identifiers within the user interface separate from or in addition to autocompletion options. These product identifiers may not depend on supplied human query input and can use alternative data sources such as products in near proximity to the item, store product location data, shopper data, and the like. One or more candidate products may be based on partial identification data. For example, a product identified with 70% confidence as a first product will preferably present that product as one option if it was the highest or one of the highest likely candidates based on CV monitoring and/or other data analysis.

The candidate product identifiers are preferably represented graphically. They may be organized according to priority or in any suitable organization. The candidate product identifiers are preferably selectable elements within a user interface of the product mapping tool 130. Selection of a candidate product identifier is preferably used in selecting that as the determined product identifier. The candidate product identifier may additionally enable user interface options to inspect the option such as to view a close up of that product or to view additional product information like size and price.

A selected product identifier is preferably an output of the product mapping tool 130. The product identifier output can be relayed to the CV monitoring system 110 or other suitable system to facilitate resolving any exceptions caused by previous inability to identifier an item.

In one variation, redundant evaluation of an identification task may compare multiple distinct selected product identifiers supplied by different product mapping tool instances. That is to say the product identifiers selected by two or more users of the product mapping tool can be compared. If there is agreement or other forms of consensus between the selected product identifiers then that product identifier can be used as the selected product identifier for updating of the CV monitoring system.

In one variation, the selected product identifier from the product mapping tool is communicatively relayed to the CV monitoring system, which is configured to update an environment model based on the selected product identifier. In one variation, configuration of the CV monitoring system updates item-associated data of an environment model to be associated with the selected product identifier, which functions to update the item to be identified as the indicated product of the product identifier.

In one variation, this is used to update a map of product shelf placement with item location and product identity. When the system is operated across an environment this can be used to build an at least partial planogram (e.g., a map of product placement on shelves in a store). Such mapping of product identity and location could alternatively be used in any suitable application that can

In another variation, the selected product identifier is used to update a data model of user activity in the environment as it relates to the item. For example, an unidentified item detected as being added to a customer's cart (and thereby tracked as an unidentified item in the customer's virtual cart) can be updated to the corresponding product identifier. In cases where this update to the unidentified item occurs before a checkout event, an automatic or semi-automatic checkout process can proceed despite the product being unidentified at the time of customer selection.

The product identifier output may additionally or alternatively be communicated to a training system of the CV monitoring system 110, which functions to improve or enhance the CV processing model of the item detection module 120. This preferably establishes training data for CV detection of that item. In one variation, it creates a single training pair of image data to product identifier. In other variations, additional image data can be collected that corresponds to that item. In one variation, all image data (and segments of that image data) from different imaging devices can be added as training data. In another variation, image data of the item that is collected by tracking the item after selection may be used as training data. For example, different instances where related image data could be collected could include when a customer selects an item, image data from the shelf, when in the customer's hand, when in the physical cart and viewed at different positions while the cart is moved in the store, and/or handling of the item during a stocking event.

### 3. Method

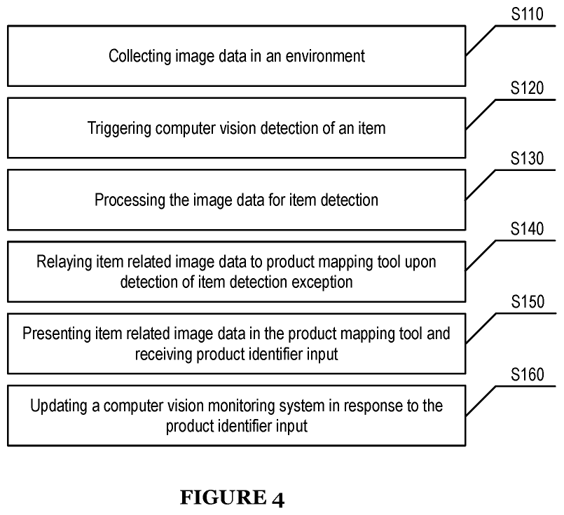

As shown in FIG. 4, a method for on-boarding products for computer vision detection of a preferred embodiment includes collecting image data in an environment Silo, triggering computer vision detection of an item S120, processing the image data for item detection S130, relaying item related image data to a product mapping tool upon detection of item detection exception S140, presenting image data in the product mapping tool and receiving product identifier input S150, and updating a computer vision monitoring system in response to the product identifier input S160.

The method is preferably implemented through a system substantially similar to the one described herein but may alternatively be implemented with any suitable system. The method is described primarily as it may be applied to a CV monitoring system identifying products in a retail setting, but the method may additionally or alternatively be used in facilitating on-demand, remote item identification for any suitable computer vision system.

The method can be implemented as a supplementary process to an ongoing computer vision or other type of sensor-based monitoring system. For example, an automated or semi-automated checkout system using computer vision and/or other sensor inputs maybe initiate the product identification method for reacting to unidentified products in the store such as when a customer adds an unidentified product to their cart. The method may alternatively be implemented as part of a routine item detection and identification process used for tracking and monitoring items in an environment. As another retail example, the method may be used for generating a planogram of a store and updating the planogram. Additionally or alternatively, the method may be used in improving the CV and/or sensor based detection of items by using the results of the product identification input.

The method can be implemented for a CV monitoring system implemented within one environment, but the method could additionally be implemented across a set of distinct environments.

Block S110, which includes collecting image data in an environment, functions to collect video, pictures, or other imagery of a region containing objects of interest (e.g., inventory items). Image data is preferably collected from across the environment from a set of multiple imaging devices. Preferably, collecting imaging data occurs from a variety of capture points. The set of capture points include overlapping and/or non-overlapping views of monitored regions in an environment. Alternatively, the method may utilize a single imaging device, where the imaging device has sufficient view of the exercise station(s). The imaging data preferably substantially covers a continuous region. However, the method can accommodate for holes, gaps, or uninspected regions. In particular, the method may be robust for handling areas with an absence of image-based surveillance such as bathrooms, hallways, and the like.

The imaging data may be directly collected, and may be communicated to an appropriate processing system. The imaging data may be of a single format, but the imaging data may alternatively include a set of different imaging data formats. The imaging data can include high resolution video, low resolution video, photographs from distinct points in time, imaging data from a fixed point of view, imaging data from an actuating camera, visual spectrum imaging data, infrared imaging data, 3D depth sensing imaging data, parallax, lidar, radar, sonar, passive illumination, active illumination, and/or any suitable type of imaging data.

The method may be used with a variety of imaging systems, collecting imaging data may additionally include collecting imaging data from a set of imaging devices set in at least one of a set of configurations. The imaging device configurations can include: aerial capture configuration, shelf-directed capture configuration, movable configuration, and/or other types of imaging device configurations. Imaging devices mounted over-head are preferably in an aerial capture configuration and are preferably used as a main image data source. In some variations, imaging devices may include worn imaging devices such as a smart eyewear imaging device. This alternative movable configuration can be similarly used to extract information of the individual wearing the imaging device or other observed in the collected image data.

Block S120, which includes triggering computer vision detection of an item, functions to initiate item detection through a computer vision monitoring system. Triggering (or initiating) of item detection can be based on a variety of factors, but is preferably performed when the identity of an item in the environment is not known or confirmed and information on the item is needed for digitally modeling the environment.

In one variation, a CV monitoring system can include continuously or periodically performing item detection processing of image data. In one variation, the CV monitoring system may monitor changes in image data and for image data changes refresh image detection for the changed image data, which functions to reduce CV processing. In a related variation, the method can include CV processing of the image data that includes segmenting background image data from the image data and periodically performing item detection processing of the background image data. Segmenting background image data can be used to extract image data of stored products in the environment. For example, in a retail environment, the shoppers, workers, carts and other movable items will be foreground elements and so extracting the background image data generates image data of the stored products (along with other stationary items). Changes in the background image data may be used to trigger an attempt of item detection. In another variation, the CV monitoring system may schedule item detection. For example, item detection may be updated every day or hour.

In another variation, a CV monitoring system can perform item detection in response to an interaction related trigger event. One preferred trigger event can be a user interaction event. Triggering computer vision detection of an item can include in such variations, detecting a user-item interaction with the item. The CV monitoring system can track users through the environment and monitoring users for user-item interactions. User-item interactions may be detected through detection of physical interaction observed in the image data such as detection of a user picking up an item. User-item interaction may alternatively be detected through user to item proximity. For example, a user-item interaction event may trigger when a user gets within a certain proximity to an item. Additional conditions could include, direction of a user's attention such as whether a user is facing an item on a shelf. In a store, user-item interactions can be tracked for customers, but may additionally or alternatively tracked for workers such as detecting stocking events. User-item may be detected through a specific CV processing model or models architecture customized for detection of such user-item interactions. Detection of a user-item interaction may be agnostic to the actual item involved in the user-item interaction and therefore performing of item detection on the involved item of the user-item interaction can supply the desired product information.

One exemplary user-item interaction event is when a customer selects an item for purchase. In this way, item detection can be deferred to the moment when its identity can provide utility.

Another exemplary user-item interaction event can be when a worker (or other user) adds an item to a shelf such as during a stocking event. In this variation, item detection can be performed as soon as an item as added, which may sufficient time for the item to be identified.

The image data involved in the item detection triggered by a user-item interaction event can be from before, during, and/or after the detected user-item interaction. In some cases item related image data can be collected from before, during and after to provide a diversity of image data that can be useful in labeling a product.

Triggering of item detection can alternatively be based on routine execution of item detection. In some implementations of the method, triggering of item detection is not based on any suitable external trigger and instead item detection is performed routinely or periodically where if not item is detected then the method does not proceed with subsequent processing until the next attempt. Accordingly, some variations of the method may include collecting image data in an environment S110, processing the image data for item detection S130, relaying item related image data to a product mapping tool upon detection of item detection exception S140, presenting image data in the product mapping tool and receiving product identifier input S150, and updating a computer vision monitoring system in response to the product identifier input S160.

Block S130, which includes processing the image data for item detection, functions to execute a CV-based item detection process thereby yielding some item detection result. The CV detection of an item will preferably include locating an item and attempting identification and/or classification. In a variation relating to commerce, triggering CV detection includes triggering attempted product identification of a detected item. Item identification may be limited to only items matching particular characteristics such as only items stocked on shelves or other display areas. Item identification may additionally include classifying objects as products or non-products, segmenting items or groups of items. Processing the image data for item detection preferably includes processing the image data with an image detection CV processing model. For example, a CNN or other suitable neural net or other deep learning or machine learning model or processing pipeline can be used. Identifying of a product preferably involves applying of a computer vision model/algorithm, but may additionally or alternatively use other data such as data collected from other sensors, contextual data such as planogram information, historical data (e.g., historical shelf stocking records, user/shopper records), and/or other suitable information.

Processing the image data can result in no detection of an item, positive detection of an identified item, or detection of an unsuccessfully identified item. In some cases, multiple items may be detected in the image data. Item detection can additionally be limited to a region of interest of the image data. Negative detection of an item (i.e., no item detected or located) may mean there is no item present in the image data and therefore no further processing is needed. In some cases however, such a setting may be considered a detection exception and further review through a product mapping tool may be desired.

Positive detection of an identified item (i.e., a successful case) can result in a product visible in the environment being mapped to a corresponding product identifier. Positive detection is when processing of the image data by the CV processing model yields a result with an accepted confidence level. The identified product identifier may have associated data such as a product name, price, and/or other related information. Successful detection preferably involves identifying a product with at least some minimum amount of confidence.

Unsuccessfully identified items preferably result from the CV processing model yielding detection of an item without identifying or classifying the item with a product identifier with an accepted confidence level. Unsuccessful identified items can result in an item detection exception. In some cases, it may have no suggested product identifier. In other cases, a product identifier may be produced by the CV processing model but without accepted confidence level. Additionally or alternatively, redundancies in the identification process may detect anomalies or other situations that can result in an exception. For example, if a CV processing model does not agree with additional sensor data input (e.g., input from a smart shelf) then an item detection exception may be issued.

In the event item detection does not encounter an exception, the item identity can be used in any suitable manner. For example, detection of a product identifier for an item through CV item classification/identification can be used to facilitate tracking of products selected by a customer for purchase.

In the event an item detection exception occurs, a product mapping tool can be used for remote identification applying human assisted labeling/mapping. An exception could be when item identification fails and no candidate identifiers can be generated. An exception could also be when item identification fails to satisfy some identification conditions. For example, the confidence level of an item classification model may be reported as being below a minimum threshold. Another identification condition that triggers an exception could be when item identification has a sufficiently high confidence level but item location does not correspond to an expected location of the item. For example, if the CV monitoring believes it successfully identified a box of cereal but it is located in the pet food section, then labeling assistance may be triggered.

Block S140, which includes relaying item related image data to a product mapping tool upon detection of item detection exception, functions to communicate the image data for remote, human-assisted identification. Relaying the image data preferably includes communicating the image data to a product mapping tool of a remote client device or multiple client devices. The image data is preferably performed over a network or other suitable data channel. The item related image data is preferably communicated as part of an item identification task request that can be interpreted by the product mapping tool in updating a user interface and data records associated with the task request. A work management system (e.g., a computer-implemented work management system) may function in queuing work and assigning to appropriate workers.

Relaying item related image data may include collecting item related image data. Collecting item related image data may include collecting localized image data from a region of the item. This may use the location information of the item resulting from the item detection process. Collecting item related image data may additionally or alternatively include collecting image data prior to, during, and/or after some period. The image data could be collected from the same imaging device or different imaging devices. Collecting item related image data can additionally include tracking the item (or a user) for collection of additional data. This tracking can be forward in time or backgrounds in time for time series image data.

Image data that is relayed could include: the image data processed by the CV monitoring system; image data automatically selected as “best” images for human review, supplementary image data from other imaging devices (where the product was displayed and/or along the path of the product if it was moved through environment by a user), historical image data (e.g., image data from stocking event, from a day ago, from a week ago, etc.); image data of contextual information (e.g., price tags, adjacent products); and/or any suitable forms of image data. Additional non-image data may additionally be pulled and supplied to the product mapping tool.

Relaying item related image data can include prioritizing and queuing item identification tasks. Different item identification tasks can have different urgencies, challenge levels, and/or other attributes. Relaying the items can additionally include intelligently assigning the tasks to one or more agents from a set of agents. Different agents may have differing levels of experience, knowledge, quality/accuracy, speeds, language abilities, and/or other attributes. Accordingly, a set of agents working to identify products based on communicated image data and supplemental data may have a supply of tasks distributed across agents to enhance output, workload, quality, or other outcomes.

In another variation, prioritizing and queuing item identification tasks can be based on a predicted user path. This variation may include predicting a user path to a checkout region and prioritizing tasks associated with users that are closer to reaching a checkout region. In one implementation an expected time for a user to reach a checkout region can be used. In some automated forms of checkout item identification may be targeted for completion prior to reaching the checkout region or so after leaving the checkout region/store. Alternative, predictions may be used to better understand deadlines or targets for completing a task.

Block S150, which includes presenting image data in the product mapping tool and receiving product identifier input, functions to provide a user interface for user exploration of an item of interest and setting of item to identifier mapping. Variations of block S150 can provide unique enhancements and capabilities making the product mapping tool intelligent to significantly make the identification process faster and easier. Identification of a product with one image can be challenging when the image of the item may be small or from an odd angel (which can be the case if viewed with an aerial mounted camera). Furthermore, locating the product information and entering it can be time consuming traditionally. However, presenting image data in the product mapping tool can include a variety of data-driven and computer implemented enhancements to automate and intelligently provide assistance.

As discussed, the item is preferably a product, and the identifier is preferably a product identifier. A product identifier could be in the form of a UPC, SKU number, or any suitable identifier for a product within some system. A product identifier may additionally be related to a product data model which may include a variety of product related data and information. Product identifier input indicates the product (or other suitable type of item information) is to be associated with the item.

Presenting image data preferably includes presenting at least one image of the item of interest. The image data may be from when the item detection was attempted. The image data may additionally or alternatively include image data from before the item detection exception or after the item detection exception. As an example of image data from before the exception, image data from a before detection was attempted may show a non-occluded item. As another example of image data from before the exception, image data from a before detection was attempted may show image data from a stocking or shelving event. As an example of image data from after an exception can include image data collected of the item as the item was tracked through the environment using CV monitoring. As a specific example, images of the item while in the shopping cart of a customer and when placed on a conveyor belt at a checkout stand may be used as image data. A user of the product mapping tool may additionally be enabled to request or explore the image data by playing video, request to view different types of image data, select camera views, and/or make other adjustments. Based on such requests, appropriate image data can be queried and accessed for presenting in the product mapping tool.

Block S150 may additionally include providing supplementary item information such as image data or information relating to adjacent products/items, historical information related to that shelving position, data based on more generally detected details of a product, product placement data from other store locations, shopper history for a user interacting with the item, and/or other suitable information. The supplementary item information may be discretely gathered. The supplementary item information may additionally or alternatively include predictive information. For example, a list of products resulting from CV processing (which could be deemed a detection exception for a variety of situations). Alternative image and/or data analysis techniques may also be used in such identifications. For example, a set of candidate products can be prioritized based on image pattern matching. Such techniques such as use of a color histogram may not be sufficient for identification individually but may provide assistances within the product mapping tool especially when combined with other tools for determining the product identity.

In some cases, the supplementary item information may be supplied as general information, but in other cases, the supplementary information can be used to render/provide various types of assistant user interface elements. In one variation, a specific product identifier may not be detected, but general information about the item may be detected such as the brand name or general product name. These could be presented as selectable options in a product search field. In some implementations, these may be automatically selected to automatically narrow the search query.

In association with operating the product mapping tool, the method can include generating a set of candidate product identifiers and within the product mapping tool presenting the set of candidate product identifiers. Receiving product identifier input can include receiving selection of one of the set of candidate product identifiers. Presenting the set of candidate product identifiers can include presenting a graphical representation of one or more of the set of candidate product identifiers within the user interface. The graphical representation may include one or more images of the associated product. The graphical representations can additionally be interactive user interface elements where a user can perform various actions through the user candidate product interface element.

The set of candidate product identifiers can be created in a variety of ways. The candidate products may be generated using image based search, data analysis of known product locations within the environment and in other similar environments, user data records associated with the item, and/or other approaches. Furthermore, the set of candidate product identifiers may be modified and updated with more supplied input. In some options the product mapping tool may enable user control over how the set of candidate products is generated. For example, a user could toggle image-based search assistance, toggle shelving data input, and/or supply product information, yielding a customized assortment of candidate products.

In one variation, generating the set of candidate product identifiers is based in part on performing an image search of the item related image data across a database of product images. As discussed this image search may not be strictly for matching but can be for prioritizing products by various features such as color histogram matching, texture profiles, detected text or graphics, and/or other forms of image search. Image-based search is preferably combined with other features for discovery of a determined product identify. For example, image search can be used with query input in filtering the set of candidate products.

Block S150 may additionally include providing a query input field, which function to populate a user interface with possible identifiers (e.g., product identifiers). The input to the query input field is preferably used in filtering a set of candidate product identifiers based at least in part on input of the query input field. In some implementations the query input field can be an autocompletion query input field, wherein results can be rendered reactively as a query or information is supplied. The user interface with suggested identifiers may alternatively be any suitable interface. Providing an query input field preferably includes acquiring at least one of user input and/or supplemental item information, querying a database of identifiers and retrieving a set of identifier results, and prioritizing the set of identifier results. An agent can preferably continue modifying their input and/or select an appropriate candidate product identifier when the agent finds it. The query process and/or the prioritization may use any suitable combination of query input and supplemental information. As one example, user input is used to search a database of items and filter results based on item location information such as aisle information and adjacent/nearby products. In some instances such process can be performed with no user input (i.e., using a blank query input). The query input field can be an open text field, but may additionally or alternatively include one or more parameter defining user interface elements. For example, there could be a product category selection box, a brand selection box, a packaging type selection box, and/or any suitable type of user interface. In some cases, input can be supplied through automatically detecting one or more product classifications and filling the query input field.

As an additional or alternative variation, a query interface can integrate with a real-time crawling system that access one or more outside sources of item identity information. The sources can include online marketplace, product suppliers, and/or other sources. Product searches and queries can preferably be performed and updated in response to user input.

While a query interface may be one type of user interface, the product mapping tool can include or be other suitable types of user interfaces. For example, a product identifier may be discovered and selected using a product labeling tool where a user defines the product by supplying a set of information and from that a set of candidate products is produced and one can be selected.

The database of identifiers is preferably compiled from an inventory list of known or potential identifiers. This database can be specific for a given environment, but may alternatively be compiled for shared use across multiple distinct environments.

In some variations, the method may include compiling an item identifier database. Compiling an item identifier database may include ingesting one or more item lists. The item lists could be inventory lists from the environment/store, item order lists, planograms, or other suitable sources. Compiling an item identifier database may additionally or alternatively include crawling the public internet for item information. Compiling the item identifier database can include crawling and scraping product information from online marketplaces, product suppliers, and/or other sites. Crawling and scraping product information can include performing queries through one or more resources. This can include performing product searches. The searches can be text based. The supplied text could be based on user input but may additionally include searching using supplemental item information. In one variation, the dimensions, product color, packaging text, brand detection, and/or other attributes of an item can be detected and used to scope or at least partially define the search.

Searches may additionally include supplying image data to an image query tool that identifies similar products. The image search tool may use a general image search tool. Alternatively, images from one or more sites can be indexed and image search can be performed across those images.

In one variation, image search and text searching can be used cooperatively, where both techniques used in combination to efficiently identify a set of candidate items.

Searching may alternatively or additionally include accessing item information from one or more sources using an application programming interfaces (API).

Receiving product identifier input preferably includes mapping at least a product identifier attribute to the image data. Preferably, the product identifier attribute will have additional related attributes such as a human readable name, one or more display images (for use in user interfaces), pricing information, product information, item standard physical properties (e.g., weight, dimensions, etc.). In some variations, the item related attributes are supplied through the item identifier database. In some variations or in some instances, an item related information may not be available for a particular item. The agent may need to input this information. The product mapping tool or an outside tool (e.g., web browser) may be used to find the information such as product pricing information and add it.

In maintaining item identifier database, the method can include resolving conflicts in item related information, which functions to consolidate information, fix conflicting information, merge duplicate records, and/or otherwise maintain a record for detectable records.

Block S160, which includes updating a computer vision monitoring system in response to the product identifier input, functions to use the item-to-identifier mapping. The product identifier input can be used alter the current modeling of the environment managed at least in part by the CV monitoring system. The product identifier input can additionally or alternatively be used to improve the capabilities of the CV monitoring system my updating or improving the CV processing model used within the CV monitoring system. With sufficient collection of image data of the item, subsequently encountered instances of the same type of item may be identified using the updated CV processing model.

In one variation, updating the CV monitoring system in response to the product identifier input can include applying the product identifier to an environment model based on the product identifier input. The environment model is preferably the data model generated by the CV monitoring system (or alternative type of sensor-based monitoring system) used in representing the state of the environment. The environment model can be used to model interactions in the environment (e.g., user activity and interactions with items), or it could be static/state based observations such as the name and location of different items. The environment model can indicate product storage locations, inventory status, customer-product analytics, virtual cart data of users for forms of automated checkout, and/or other suitable modeling in the environment.

In updating the environment model, the item identifier can be supplied to the CV monitoring system or another system and used to update the item detection information for that particular instance of an item. In the automatic checkout use case, an item that was encountered an item detection exception can be updated to be modeled as mapping to the item corresponding to the item identifier. For example, a product initially unidentifiable when a customer adds it to their cart, can be updated, potentially in real-time. In some cases, this update may be performed prior to some secondary event such as a checkout process, which can enable the secondary event to proceed.

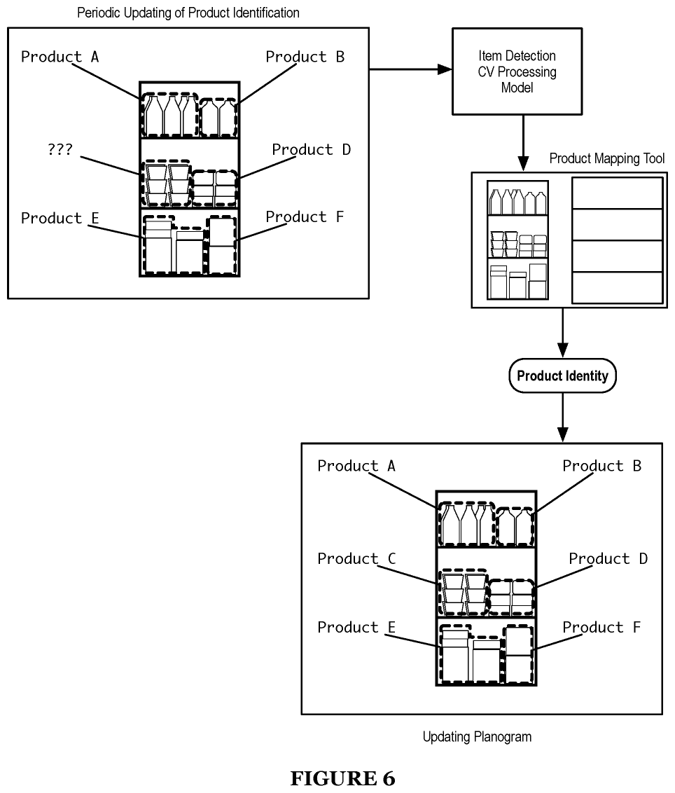

In one variation, applying the product identifier to the environment model can include updating the item location with the product identifier within a map of product shelf placement. In this variation, processing the image data for item detection includes detecting an item location on a shelf, and that item location can be updated to be the product identifier as shown in FIG. 6. The map of product shelf placement can be used in forming a planogram of one shelf or of a set of shelves in the environment.

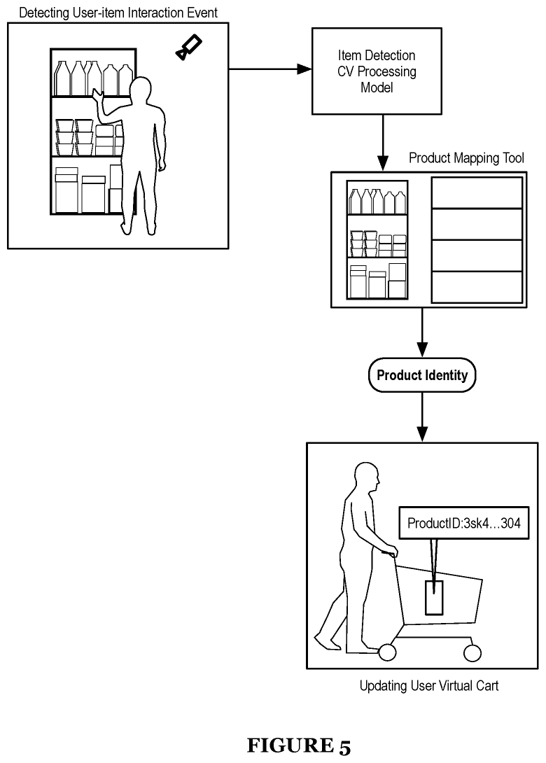

In variations such as the automated checkout variation, applying the product identifier to the environment model comprises labeling a product identity of the item involved in a user-item interaction. This can be used to assign a product identifier to an unidentified product selected by a user as shown in FIG. 5. That unidentified item may be part of a virtual cart of the user, and labeling the product identity of the item can be used in determining the price of the item and used in generating a checkout total for the virtual cart.

In a variation that can improve CV detection, updating the CV monitoring system in response to the product identifier input can include updating the computer vision processing model based on mapping of the item identifier input to item related image data. This variation is preferably used in augmenting the CV processing model used in item detection of block S130. Augmenting the CV processing model can include supplying the item related image data in the training or updating of a CNN model or other type of CV processing model.

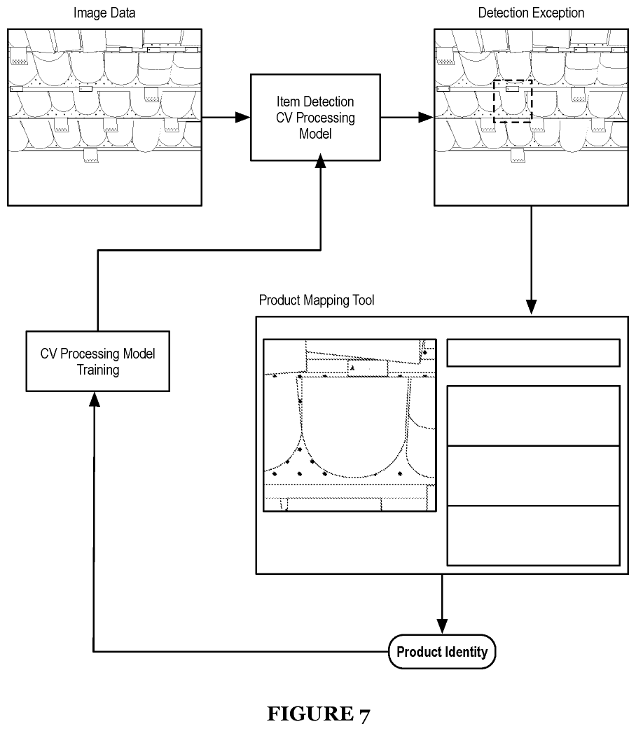

Updating the CV monitoring system may additionally include updating CV item detection process with image data updated based on mapping of image data and the item identifier as shown in FIG. 7. In the base situation, the direct image data collected of the item and the identifier are added to a training set of images. Updating CV item detection may additionally include collecting a set of diverse image data samples paired to the image data.

Collecting a set of diverse image data can include at some point tracking the item and adding the item relevant image data to the training set. Tracking the item may include tracking forwards and/or tracking backgrounds through time-series image data. For example, image data from when users later pick up the item and add the item to the cart could be selected and used as training data. This item related image data can be similar and/or the same as the item related image data

A new item may need to be labeled through the item mapping tool multiple times before the CV item detection model can successfully identifier the item.

The various processes and features described above may be combined in any suitable combination. Furthermore, such features may be applied to a variety of use cases.

The method is preferably used in determining an item identifier. The method can additionally or alternatively be used in obtaining any suitable type of item label coordinated with operation of a computer-implemented computer vision monitoring system. In one variation, the method is applied to remote SKU on-boarding of products for subsequent video identification. This identification may then be used in selling the product through an automated checkout system. This identification may alternatively be used for generation and maintaining of a planogram or other suitable type of map of product shelf placement. The product identification could alternatively be used in applying a product label for any suitable CV-based environment model.

As a detailed description of various preferred implementation variations, the method may include: collecting image data in an environment; triggering computer vision detection of an item; processing the image data for item detection; relaying item related image data to a product mapping tool upon detection of item detection exception; presenting the item related image data in the product mapping tool and receiving product identifier input; and updating a computer vision monitoring system in response to the product identifier input. The method is preferably used for remote identification, and so relaying the image data includes communicating the image data to a product mapping tool of a remote client device.

As one CV modeling variation, processing the image data can include identifying a product identity with a computer vision processing model; and updating a computer vision monitoring system in response to the product identifier input can include updating the computer vision processing model based on mapping of the item identifier input to item related image data. The CV modeling variation can function to enable on-demand enrollment of products into a CV processing model such as a convolutional neural network (CNN) or an alternative machine learning, deep learning, or statistical model. Furthermore, the method can include collecting item related data. More specifically, the method can include tracking the item and collecting item related image data. Tracking the item can include tracking the item forward in time and/or tracking backgrounds in time within time series image data. For example, item related image data could be collected from the item during stocking by tracking backwards in time. In another example, item related image data could be collected from the item placed in a shopping cart and/or placed on a conveyor belt for checkout by tracking forward in time.

In another variation, the method is used in labeling items within a tracked environment model. In this variation, updating the computer vision monitoring system in response to the product identifier input can include applying a product identifier to an environment model based on the product identifier input. The product identifier can be a SKU identifier, a Universal Product Code (UPC), a Price Look-Up code (PLU code) for produce, an International Standard book Number (ISBN) for books, and/or other suitable identifiers. The environment model can be a computer vision based representation of the environment. The environment model may additionally incorporate other types of sensor data such as smart shelf activity data and/or other types of environment monitoring data. The environment model can be used to model interactions in the environment (e.g., user activity and interactions with items). For example, the method can be used in an automated checkout variation labeling products of unknown items in the tracked virtual carts of a user. The environment model can additionally or alternatively model and track static state based observations such as the name and location of different items. For example, the method can be used in a shelf map/planogram variation labeling unidentified items within a map of product shelf placement.

In a shelf map variation, processing the image data for item detection can include detecting an item location on a shelf; and applying the product identifier to the environment model can include updating the item location with the product identifier within a map of product shelf placement. When used in combination with positive item detection can be used in generating and updating a full map of product placement within an environment. The map can serve as a planogram.

In an automated checkout variation, applying the product identifier to the environment model comprises labeling a product identity of the item involved in a user-item interaction. This functions to apply a product label to an item associated with the user. The user and item may become associated through detecting a user-item interaction with CV processing of the image data.

In one implementation variation, is implemented with an item detection process of a CV monitoring system. An item detection process may be used in detecting and mapping stored products within an environment. An item detection process may be used in detecting and tracking items passing through some region. The item detection can be performed routinely. In one variation, triggering computer vision detection of the item includes periodically performing item detection processing of the image data. The processing of the image data may additionally be only for select regions such as regions that had a change. One variation of periodic item detection can include periodically segmenting background image data from the image data and performing item detection processing of the background image data. Segmenting background image data functions to isolate background image data. More specifically, this can include isolating the statically displayed items in an environment, which would include products stocked on shelves and in other storage elements. The item detection may alternatively be performed in response to some other event or input.

In another implementation variation, the method can be performed in coordination with on-going CV processing of the image data. The image data can be processed for interaction detection and tracking. For example, a CV monitoring system may be continuously processing the image data. In one preferred variation, this can include processing the image data for tracking the items selected by users within an environment t (e.g., tracking of virtual carts of users within a store). In some variations, the method may be triggered from a detected user interaction. Triggering computer vision detection of an item can include detecting a user-item interaction with the item and thereby triggering the item detection for one or more items involved in the user-item interaction. In one variation, this could be performed after detection of the user-item interaction. In another variation, this could be performed in anticipation of a possible user-item interaction.

In a user-item interaction variation, updating the computer vision monitoring system in response to the product identifier input can include labeling the item of the user-item interaction with the item identifier. For example, a user picking up a product may be detected as an item selection user-item interaction. If the item is not suitably identified during item detection then the product identifier may be supplied through the method. The un-identified item associated with the user can then have a product identifier assigned to the item.

In one variation, presentation of item related image data may be coordinated with other item identification tasks. Different item identification tasks may have different priorities. Accordingly, the method can include generating an item identification task associated with the item related image data and where relaying item related image data is part of communicating an item identification task to the product mapping tool, and where presenting the item related image data includes presenting the item related image data of the item identification task upon selecting the item identification task from a set of item identification tasks. In one variation, the method can include prioritizing and queuing the item identification task in a set of item identification tasks. The prioritization may be based on various factors. In one variation, the source of the item identification may determine the priority. For example, an item identification task generated in response to a static item detection exception may have priority lower than a user-item interaction generated item identification task since a user-item interaction task may need to be completed with lower latency.

In one item interaction task prioritization variation, an item interaction task may be prioritized in queue according to anticipated shopping patterns of the user involved in a user-item interaction. In this variation, relaying the item related image data can include prioritizing and queuing an item identification task based on predicted user path. The method can include predicting and/or calculating time for a user to reach a checkout region and using this time to prioritize item identification tasks. For example, a user anticipated to checkout sooner may need to have the item identified faster than a user anticipated to keep shopping.

In another variation, the method can include generating a set of candidate product identifiers and within the product mapping tool presenting the set of candidate product identifiers. The method can additionally include presenting at least a subset of the candidate product identifier as selectable options in the product mapping tool. Receiving the product identifier input can include receiving selection of one of the set of candidate product identifiers.

The set of candidate product identifiers may be based on the item related image data the set of candidate product identifiers is preferably a prioritized list of products that are predicted to have a higher probability of being the item based on various item related information. The item related information may be detected from the image data, environment data and/or, other data sources. The item related information may alternatively be supplied from a user operator of the product mapping tool.

In one variation generating a set of candidate product identifiers, the set of candidate product identifiers may be based on item location in the environment. In one variation, product placement data from at least one other store location can be used in generating the set of candidate product identifiers. In another variation, identified items in proximity to the item can be used in generating the list of likely product. The method can include detecting identified products adjacent to or in proximity to the item (e.g., within 5-10 feet, stocked within 1-3 product locations, or other suitable conditions for closeness), and identifying at least one product identifier similar to the proximal items, and including the at least one product identifier in the set of candidate product identifiers. In another variation, the method can include selecting a set of identifiable items in proximity to the item, searching the product placement data of a plurality of store locations using the set of identifiable items to determine a set of candidate items that have been identified as being stocked close to the proximal items in other stores.

In one variation generating a set of candidate product identifiers, the set of candidate product identifiers may be based on shopper history for a user interacting with the item. The location of the item and previously purchased items from a similar location can be used in determining likely candidate product identifiers. For example, the three types of cereal previously purchased by a user could be included in the set of candidate product identifiers when the u-identified item is in the cereal aisle or and/or detected to be adjacent to one or more cereal boxes. The proximal items may additionally or alternatively be used in combination with shopper history. In another variation, the current detected shopping cart contents (e.g., a tracked virtual cart) may be used to predict candidate items.

In one variation generating a set of candidate product identifiers, generating the set of candidate product identifiers is based in part on product identifiers of items in proximity to the item, product placement data from other store locations, shopper history for a user interacting with the item, and/or other suitable signals.

In another variation, the method can include providing a query input field in the product mapping tool. The query input field can collect free text input from a user. The query input field may alternatively collect other forms of information such as product category selection, packaging specifications (type, size, shape, etc.), pricing information, and/or other suitable information. The query input field may be used in generating the set of candidate product identifiers. In another variation, the method can include filtering the set of candidate product identifiers based at least in part on input of the query input field.

### 4. System Architecture

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

In one variation, a system comprising of one or more computer-readable mediums storing instructions that, when executed by the one or more computer processors, cause a computing platform to perform operations comprising those of the system or method described herein such as: collecting image data in an environment; triggering computer vision detection of an item; processing the image data for item detection; relaying item related image data to a product mapping tool upon detection of item detection exception; presenting image data in the product mapping tool and receiving product identifier input; and updating a computer vision monitoring system in response to the product identifier input. The computer-readable mediums may alternatively store instructions that cause the computing platform to perform any of the processes and/or variations described herein.

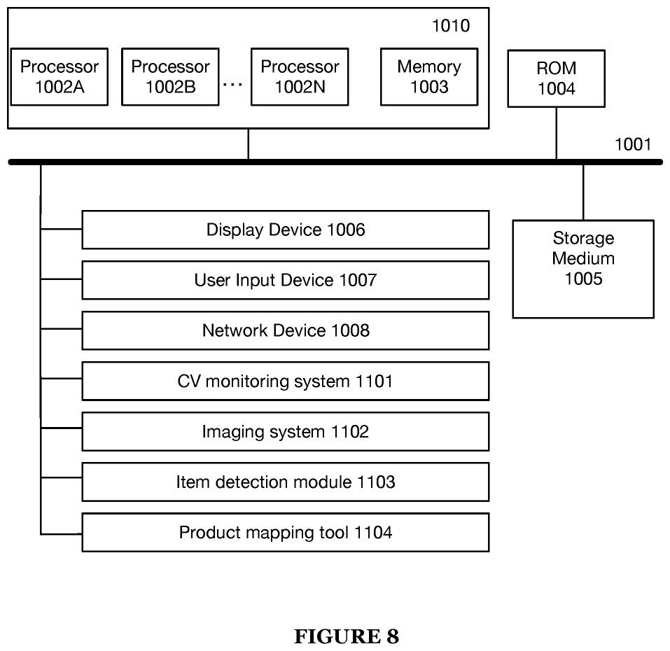

FIG. 8 is an exemplary computer architecture diagram of one implementation of the system. In some implementations, the system is implemented in a plurality of devices in communication over a communication channel and/or network. In some implementations, the elements of the system are implemented in separate computing devices. In some implementations, two or more of the system elements are implemented in same devices. The system and portions of the system may be integrated into a computing device or system that can serve as or within the system.

The communication channel 1001 interfaces with the processors 1002A-1002N, the memory (e.g., a random access memory (RAM)) 1003, a read only memory (ROM) 1004, a processor-readable storage medium 1005, a display device 1006, a user input device 1007, and a network device 1008. As shown, the computer infrastructure may be used in connecting a CV monitoring system 1101, an imaging system 1102, an item detection module 1103, product mapping tool 1104, and/or other suitable computing devices.

The processors 1002A-1002N may take many forms, such CPUs (Central Processing Units), GPUs (Graphical Processing Units), microprocessors, ML/DL (Machine Learning/Deep Learning) processing units such as a Tensor Processing Unit, FPGA (Field Programmable Gate Arrays, custom processors, and/or any suitable type of processor.

The processors 1002A-1002N and the main memory 1003 (or some sub-combination) can form a processing unit 1010. In some embodiments, the processing unit includes one or more processors communicatively coupled to one or more of a RAM, ROM, and machine-readable storage medium; the one or more processors of the processing unit receive instructions stored by the one or more of a RAM, ROM, and machine-readable storage medium via a bus; and the one or more processors execute the received instructions. In some embodiments, the processing unit is an ASIC (Application-Specific Integrated Circuit). In some embodiments, the processing unit is a SoC (System-on-Chip). In some embodiments, the processing unit includes one or more of the elements of the system.

A network device 1008 may provide one or more wired or wireless interfaces for exchanging data and commands between the system and/or other devices, such as devices of external systems. Such wired and wireless interfaces include, for example, a universal serial bus (USB) interface, Bluetooth interface, Wi-Fi interface, Ethernet interface, near field communication (NFC) interface, and the like.

Computer and/or Machine-readable executable instructions comprising of configuration for software programs (such as an operating system, application programs, and device drivers) can be stored in the memory 1003 from the processor-readable storage medium 1005, the ROM 1004 or any other data storage system.

When executed by one or more computer processors, the respective machine-executable instructions may be accessed by at least one of processors 1002A-1002N (of a processing unit 1010) via the communication channel 1001, and then executed by at least one of processors 1001A-1001N. Data, databases, data records or other stored forms data created or used by the software programs can also be stored in the memory 1003, and such data is accessed by at least one of processors 1002A-1002N during execution of the machine-executable instructions of the software programs.

The processor-readable storage medium 1005 is one of (or a combination of two or more of) a hard drive, a flash drive, a DVD, a CD, an optical disk, a floppy disk, a flash storage, a solid state drive, a ROM, an EEPROM, an electronic circuit, a semiconductor memory device, and the like. The processor-readable storage medium 1005 can include an operating system, software programs, device drivers, and/or other suitable sub-systems or software.

As used herein, first, second, third, etc. are used to characterize and distinguish various elements, components, regions, layers and/or sections. These elements, components, regions, layers and/or sections should not be limited by these terms. Use of numerical terms may be used to distinguish one element, component, region, layer and/or section from another element, component, region, layer and/or section. Use of such numerical terms does not imply a sequence or order unless clearly indicated by the context. Such numerical references may be used interchangeable without departing from the teaching of the embodiments and variations herein.

As a person skilled in the art will recognize from the previous detailed description and from the figures and claims, modifications and changes can be made to the embodiments of the invention without departing from the scope of this invention as defined in the following claims.

We claim:

1. A method comprising:
collecting image data in an environment;
triggering computer vision detection of an item;
processing the image data for item detection;
relaying item related image data to a product mapping tool upon detection of item detection exception;
presenting image data in the product mapping tool and receiving product identifier input; and
updating a computer vision monitoring system in response to the product identifier input.

2. The method of claim 1, wherein processing the image data comprises identifying a product identity with a computer vision processing model; and wherein updating a computer vision monitoring system in response to the product identifier input comprises updating the computer vision processing model based on mapping of the item identifier input to item related image data.

3. The method of claim 2, further comprising tracking the item and collecting item related image data.

4. The method of claim 1, wherein updating the computer vision monitoring system in response to the product identifier input comprises applying a product identifier to an environment model based on the product identifier input.

5. The method of claim 4, wherein processing the image data for item detection comprises detecting an item location on a shelf; and wherein applying the product identifier to the environment model comprises updating the item location with the product identifier within a map of product shelf placement.

6. The method of claim 4, wherein applying the product identifier to the environment model comprises labeling a product identity of the item involved in a user-item interaction.

7. The method of claim 1, wherein triggering computer vision detection of an item comprises detecting a user-item interaction with the item.

8. The method of claim 7, wherein updating the computer vision monitoring system in response to the product identifier input comprises labeling the item of the user-item interaction with the item identifier.

9. The method of claim 8, wherein relaying the item related image data comprises prioritizing and queuing an item identification task based on predicted user path.

10. The method of claim 1, further comprising generating a set of candidate product identifiers and within the product mapping tool presenting the set of candidate product identifiers.

11. The method of claim 10, wherein generating the set of candidate product identifiers is based in part on product identifiers of items in proximity to the item, product placement data from other store locations, and shopper history for a user interacting with the item.

12. The method of claim 10, further comprising providing a query input field, and wherein generating the filtering the set of candidate product identifiers is based at least in part on input of the query input field.

13. The method of claim 1, wherein triggering computer vision detection of the item comprises periodically performing item detection processing of the image data

14. The method of claim 1, wherein the image data is communicated to a product mapping tool of a remote client device.

15. A machine-readable storage medium comprising instructions that, when executed by one or more computer processors of one or more computing devices, cause the machine to perform operations comprising:
collecting image data in an environment;
triggering computer vision detection of an item;
processing the image data for item detection;
relaying item related image data to a product mapping tool upon detection of item detection exception;
presenting image data in the product mapping tool and receiving product identifier input; and
updating a computer vision monitoring system in response to the product identifier input.

16. The machine-readable storage medium of claim 16, wherein processing the image data comprises identifying a product identity with a computer vision processing model; and wherein updating a computer vision monitoring system in response to the product identifier input comprises updating the computer vision processing model based on mapping of the item identifier input to item related image data.

17. The machine-readable storage medium of claim 16, wherein processing the image data for item detection comprises detecting an item location on a shelf; and wherein applying the product identifier to the environment model comprises updating the item location with the product identifier within a map of product shelf placement.

18. The machine-readable storage medium of claim 16, wherein triggering computer vision detection of the item comprises detecting a user-item interaction with the item; and wherein updating the computer vision monitoring system in response to the product identifier input comprises labeling the item of the user-item interaction with the item identifier.

19. A system comprising of:
an imaging system configured to collect image data
one or more computer-readable mediums storing instructions that, when executed by the one or more computer processors, cause a computing platform to perform operations comprising:
trigger computer vision detection of an item;
process the image data for item detection;
relay item related image data to a product mapping tool upon detection of item detection exception;
present image data in the product mapping tool and receiving product identifier input; and
updating a computer vision monitoring system in response to the product identifier input.
